(19) United States
(12) Patent Application Publication
(10) Pub. No.: US 2011/0102367 A1
(43) Pub. Date: May 5, 2011

(54) CAPACITIVE TOUCH PANEL

(75) Inventors: Wei-Wen Wang, Guishan Shiang (TW); Ting-Chieh Chen, Guishan Shiang (TW); Boon-Hock Teo, Guishan Shiang (TW); Sheng-Hsien Lin, Guishan Shiang (TW); Yuh-Rur Kuo, Guishan Shiang (TW); Shih-Hsien Ma, Guishan Shiang (TW)

(73) Assignee: Transtouch Technology Inc., Taoyuan County (TW)

(21) Appl. No.: 12/938,772

(22) Filed: Nov. 3, 2010

(30) Foreign Application Priority Data
Nov. 4, 2009 (TW) 98220396

(51) Int. Cl. G06F 3/045

(52) U.S. Cl. 345/174

(57) ABSTRACT

A capacitive touch panel including a transparent substrate, a plurality of first sensing wires, a plurality of second sensing wires and an insulation layer is provided. The transparent substrate has a substrate surface. The first sensing wires are disposed on the substrate surface along a first axis direction. The second sensing wires include a plurality of bridge wires and a plurality of sensing units. The sensing units are disposed on the substrate surface along the second axis direction. The insulation layer is disposed on the substrate surface, covers the first sensing wires, and has a plurality of through holes. The through holes correspondingly expose the sensing units. Each bridge wire strides the insulation layer to electrically connect two of the sensing units.

This application claims the benefit of Taiwan application Serial No. 98220396, filed Nov. 4, 2009, the subject matter of which is incorporated herein by reference.

### BACKGROUND OF THE INVENTION

1. Field of the Invention

The invention relates in general to a capacitive touch panel, and more particularly to a capacitive touch panel whose insulation layer has through holes.

2. Description of the Related Art

Referring to FIG. 1 (prior art), a capacitive touch panel is shown. The capacitive touch panel 100 includes a substrate 102, a plurality of X-axis sensing wires 104, a plurality of Y-axis sensing wires 106 and an insulation layer 108.

The X-axis sensing wires 104 are disposed on the substrate 102. The insulation layer 108 covers the X-axis sensing wires 104 and separates the X-axis sensing wires 104 from the Y-axis sensing wires 106.

Conventionally, the X-axis sensing wires 104 and the Y-axis sensing wires 106 are disposed on the different planes, and the X-axis sensing wires 104 and the Y-axis sensing wires 106 are separated by an insulation layer 108, so that the passing light has poor penetration. Thus, the capacitive touch panel 100 has partial hue error when displaying an image.

### SUMMARY OF THE INVENTION

The invention is directed to a capacitive touch panel. The sensing units disposed on the same plane are adjacent to one another, so that the gap between the sensing units is reduced, not only increasing the color uniformity on the surface of the capacitive touch panel but also improving the display quality of the capacitive touch panel.

According to a first aspect of the present invention, a capacitive touch panel including a transparent substrate, a plurality of first sensing wires, a plurality of second sensing wires and an insulation layer is provided. The transparent substrate has a substrate surface. The first sensing wires are disposed on the substrate surface along a first axis direction. The second sensing wires include a plurality of bridge wires and a plurality of sensing units. The sensing units are disposed on the substrate surface along the second axis direction. The insulation layer is disposed on the substrate surface, covers the first sensing wires, and has a plurality of through holes. The through holes correspondingly expose the sensing units. Each bridge wire strides the insulation layer to electrically connect two of the sensing units.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (prior art) shows a generally known capacitive touch panel;

FIG. 2 shows a capacitive touch panel according to a preferred embodiment of the invention;

FIG. 3 shows a partial enlargement A of FIG. 2;

FIG. 4 shows a cross-sectional view along the cross-sectional line 4-4′ of FIG. 3;

FIG. 5 shows a cross-sectional view along the cross-sectional line 5-5′ of FIG. 3;

FIG. 6 shows the capacitive touch panel according to a preferred embodiment of the invention further including an optical film.

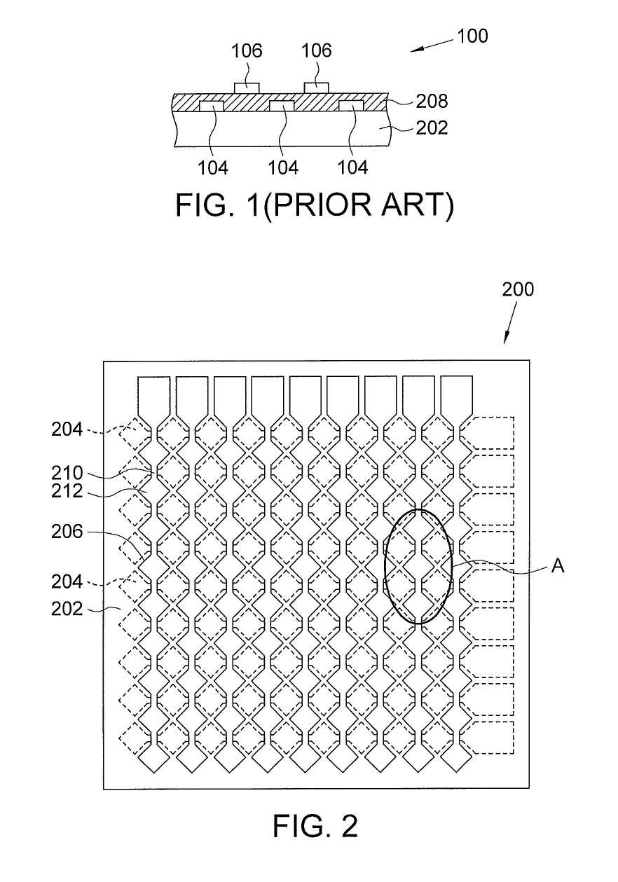

### DETAILED DESCRIPTION OF THE INVENTION

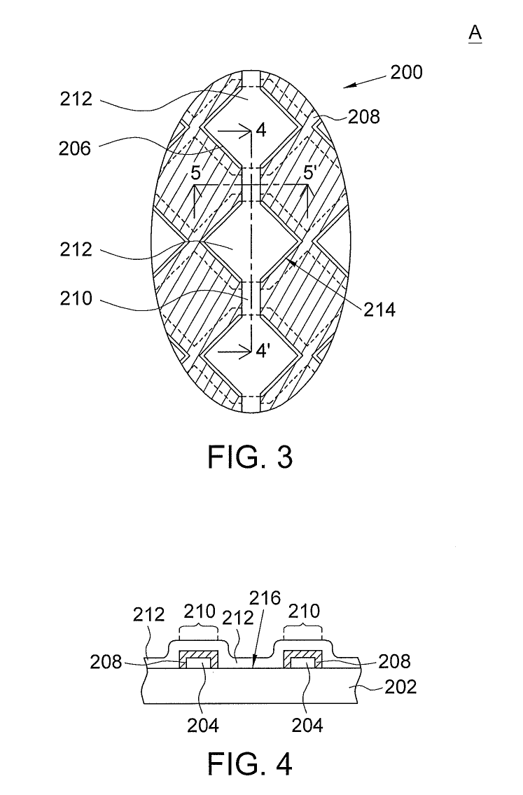

Referring to FIG. 2 and FIG. 3. FIG. 2 shows a capacitive touch panel according to a preferred embodiment of the invention. FIG. 3 shows a partial enlargement A of FIG. 2.

As indicated in FIG. 2, the capacitive touch panel 200 includes a transparent substrate 202, a plurality of first sensing wires 204, a plurality of second sensing wires 206 and an insulation layer 208 (illustrated in FIG. 3). To simplify the illustration, the insulation layer 208 is not illustrated in FIG. 2.

The transparent substrate 202 can be made from an insulating material with high transmittance such as polycarbonate (PC), polythylene terephthalate (PET), polymethylmethacrylate (PMMA) or cyclic olefin copolymer.

The second sensing wires 206 and the first sensing wires 204 can be made from indium tin oxide (ITO) or a transparent organic conductive material such as 3,4-ethylenedioxythiophene (PEDOT).

The first sensing wires 204 can be arranged along a first axis direction, and the second sensing wires 206 can be arranged along a second axis direction. The first axis direction is such as the X-axis sensing direction of the capacitive touch panel 200, and the second axis direction is such as the Y-axis sensing direction of the capacitive touch panel 200. However, the above exemplification is not for limiting the invention, and in another implementation, the first axis direction can be the Y-axis sensing direction, and the second axis direction can be X-axis sensing direction.

The first sensing wires 204 and the second sensing wires 206 can be interlaced in an array. The intersection angle between the first axis direction and the second axis direction ranges between 1 and 90 degrees and preferably is 90 degrees.

The second sensing wires 206 include a plurality of bridge wires 210 and a plurality of sensing units 212. Each bridge wire 210 strides an insulation layer 208 to electrically connect two of the sensing units 212 such as two adjacent sensing units.

As indicated in FIG. 3, the insulation layer 208 covers the first sensing wires 204 and has a plurality of through holes 214. The sensing units 212 are correspondingly disposed in the through holes 214. The through holes 214 can be formed by way of etching. In addition, the cross-sectional area of the through holes 214 is larger than that of the sensing units 212. That is, there is a gap between the through holes 214 and the sensing units 212.

Referring to FIG. 4, a cross-sectional view along the cross-sectional line 4-4′ of FIG. 3 is shown. The insulation layer 208, the first sensing wires 204 and sensing units 212 are disposed on a substrate surface 216 of the transparent substrate 202. In the present embodiment of the invention, the first sensing wires 204 and the sensing units 212 are disposed on the same surface (that is, the substrate surface 216), so that the light passing through the first sensing wires 204 and the light passing through the second sensing wires 206 have the same penetration so as to improve the display quality of the capacitive touch panel.

In comparison to the prior art, the sensing units 212 and the bridge wires 210 of the second sensing wires 206 can be formed by the same manufacturing process (such as the sputtering process) at one time according to the present embodiment of the invention, and there is no need to arrange other manufacturing process to form the bridge wires 210.

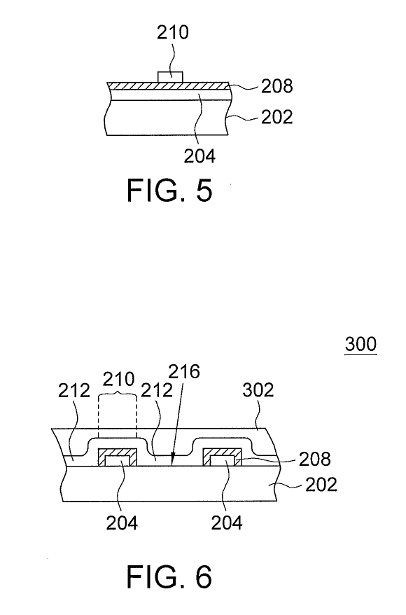

As indicated in FIG. 4, the bridge wires 210 overlap their corresponding first sensing wires 204, and both are disposed on the insulation layer 208. Furthermore, the bridge wires 210 stride the insulation layer 208 to connect the adjacent sensing units 212. Referring to FIG. 5, a cross-sectional view along the cross-sectional line 5-5′ of FIG. 3 is shown. FIG. 5 shows the cross-section of the bridge wires 210 viewed from another angle.

In the present embodiment of the invention, both the through holes 214 and the sensing units 212 are diamond-shaped, but such exemplification is not for limiting the invention, and both the through holes 214 and the sensing units 212 can have other shapes. For example, the sensing units 212 and the through holes 214 can be a circle or a polygon such as a diamond, a triangle, a rectangle, a hexagon, or an octagon.

In the present embodiment of the invention, the shape of through holes 214 corresponds to that of the sensing units 212. However, such exemplification is not for limiting the invention, and the shape of the through holes 214 can be different from that of the sensing units 212.

Referring to FIG. 6, the capacitive touch panel according to a preferred embodiment of the invention further including an optical film is shown. The capacitive touch panel 300 further includes an optical film 302, which covers the second sensing wires 206. The optical film 302 enhances the transmittance. Preferably, the refractive index of the optical film 302 is smaller than 1.7. The materials of the optical film 302 include silica, magnesium fluoride, alumina or yttria, and preferably include silica.

According to the capacitive touch panel disclosed in the above embodiments of the invention, the sensing units disposed on the same plane are adjacent to one another, so that the gap between the sensing units is reduced, not only increasing the color uniformity on the surface of the capacitive touch panel but also improving the display quality of the capacitive touch panel. Also, in present embodiment of the invention, the sensing units and the bridge wires of the second sensing wires can be formed by the same manufacturing process at one time, and there is no need to arrange other manufacturing process to form the bridge wires.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A capacitive touch panel, comprising:
a transparent substrate having a substrate surface;
a plurality of first sensing wires disposed on the substrate surface along a first axis direction;
a plurality of second sensing wires each comprising a plurality of bridge wires and a plurality of sensing units, wherein the sensing units are disposed on the substrate surface along a second axis direction; and
an insulation layer disposed on the substrate surface, wherein the insulation layer covers the first sensing wires and has a plurality of through holes, which correspondingly expose the sensing units;
wherein, each bridge wire strides the insulation layer to electrically connect two of the sensing units.

2. The capacitive touch panel according to claim 1, wherein the cross-sectional area of each through hole is larger than that of the corresponding sensing unit.

3. The capacitive touch panel according to claim 1, wherein intersection angle between the first axis direction and the second axis direction is 90 degrees.

4. The capacitive touch panel according to claim 1, wherein the first sensing wires and the second sensing wires are arranged in an array.

5. The capacitive touch panel according to claim 1, wherein the shape of each through hole corresponds to that of each sensing unit.

6. The capacitive touch panel according to claim 1, wherein each sensing unit is circular.

7. The capacitive touch panel according to claim 1, wherein each sensing unit is polygonal.

8. The capacitive touch panel according to claim 7, wherein each sensing unit is diamond-shaped.

9. The capacitive touch panel according to claim 1, further comprising:
an optical film disposed on the insulation layer and covering the second sensing wires.

10. The capacitive touch panel according to claim 9, wherein the refractive index of the optical film is smaller than 1.7.

11. The capacitive touch pane according to claim 10, wherein the materials of the optical film include silica, magnesium fluoride, alumina or yttria.
